(19) United States
(12) Patent Application Publication
(10) Pub. No.: US 2025/0099790 A1
(43) Pub. Date: Mar. 27, 2025

(54) FIRE SUPPRESSION SYSTEM FOR TRACTOR TRAILERS

(71) Applicant: GEOFFREY SICKLER, HAGERSTOWN, MD (US)

(72) Inventor: GEOFFREY SICKLER, HAGERSTOWN, MD (US)

(21) Appl. No.: 18/372,740

(22) Filed: Sep. 26, 2023

(51) Int. Cl. A62C 3/07; A62C 3/06; A62C 37/40

(52) U.S. Cl. CPC A62C 3/07; A62C 3/065; A62C 37/40

(57) ABSTRACT

The fire suppression system for tractor trailers includes a reservoir, a pump, a plurality of spray nozzles, and a plurality of impact sensors. The reservoir, the pump, the plurality of spray nozzles, and the plurality of impact sensors may be coupled to a truck. Responsive to an impact, the fire suppression system for tractor trailers may spray a fire suppression agent carried within the reservoir onto an impacting vehicle to prevent ignition of a fire or to extinguish the fire such that the fire is prevented from reaching a flammable cargo. As non-limiting examples, the truck may comprise a tanker and the flammable cargo may be a fuel or a chemical.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the fields of fire suppression systems and vehicular safety systems, more specifically, a fire suppression system for tractor trailers.

### SUMMARY OF INVENTION

The fire suppression system for tractor trailers comprises a reservoir, a pump, a plurality of spray nozzles, and a plurality of impact sensors. The reservoir, the pump, the plurality of spray nozzles, and the plurality of impact sensors may be coupled to a truck. Responsive to an impact, the fire suppression system for tractor trailers may spray a fire suppression agent carried within the reservoir onto an impacting vehicle to prevent ignition of a fire or to extinguish the fire such that the fire is prevented from reaching a flammable cargo. As non-limiting examples, the truck may comprise a tanker and the flammable cargo may be a fuel or a chemical.

An object of the invention is to extinguish and/or prevent ignition of a fire after an impact involving a truck.

Another object of the invention is to provide a reservoir holding a fire suppression agent and a pump that may pump the fire suppression agent onto an impacting vehicle.

A further object of the invention is to provide a plurality of nozzles that may spray the fire suppression agent onto the impacting vehicle as the fire suppression agent is pumped from the reservoir.

Yet another object of the invention is to provide a plurality of impact sensors that may detect the impact and activate the pump.

These together with additional objects, features and advantages of the fire suppression system for tractor trailers will be readily apparent to those of ordinary skill in the art upon reading the following detailed description of the presently preferred, but nonetheless illustrative, embodiments when taken in conjunction with the accompanying drawings.

In this respect, before explaining the current embodiments of the fire suppression system for tractor trailers in detail, it is to be understood that the fire suppression system for tractor trailers is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the fire suppression system for tractor trailers.

It is therefore important that the claims be regarded as including such equivalent construction insofar as they do not depart from the spirit and scope of the fire suppression system for tractor trailers. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a rear view of an embodiment of the disclosure.

FIG. 2 is a side view of an embodiment of the disclosure.

FIG. 3 is a top view of an embodiment of the disclosure.

FIG. 4 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

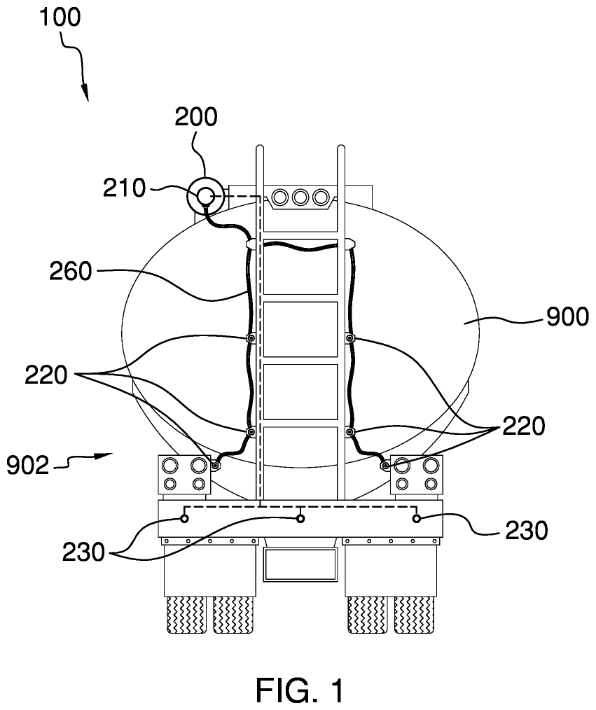

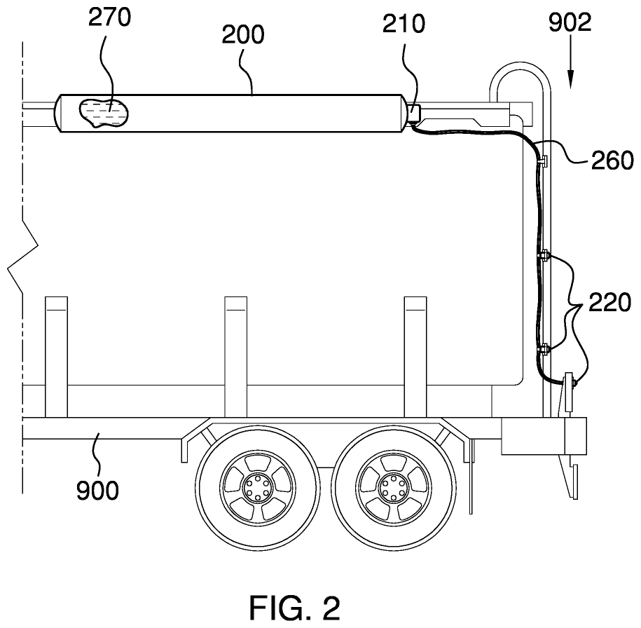

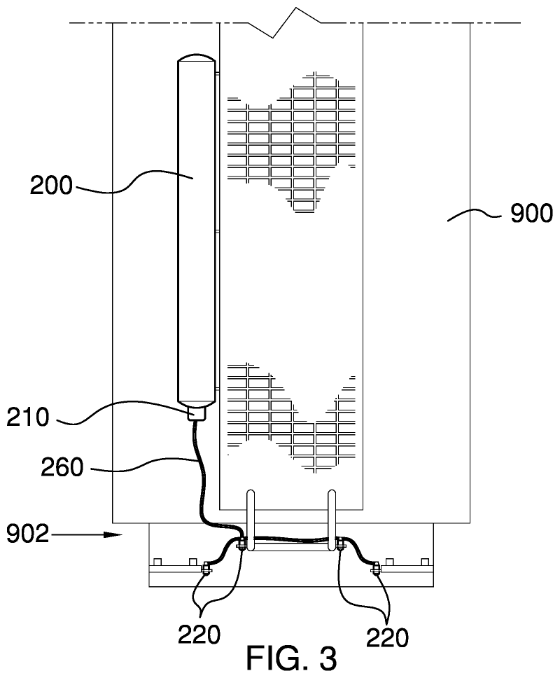

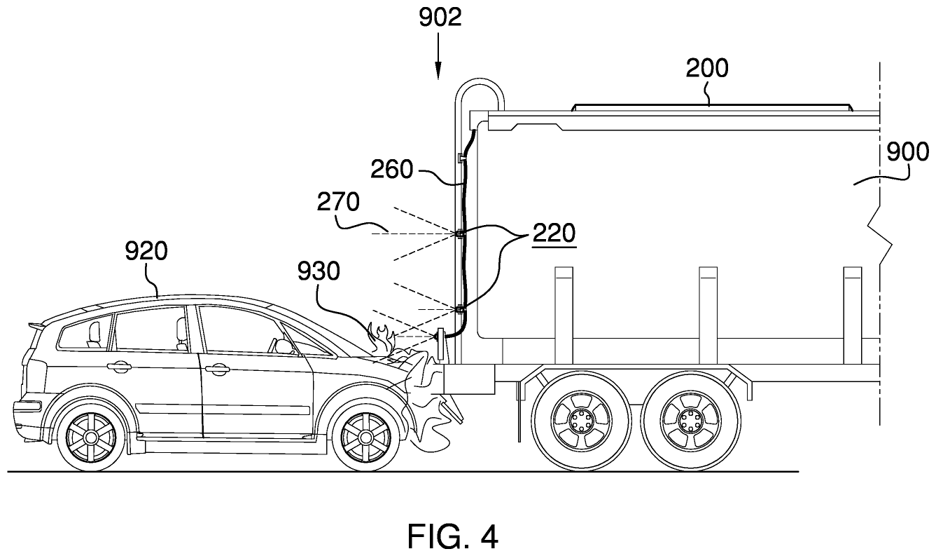

Detailed reference will now be made to a first potential embodiment of the disclosure, which is illustrated in FIGS. 1 through 4.

The fire suppression system for tractor trailers 100 (hereinafter invention) comprises a reservoir 200, a pump 210, a plurality of spray nozzles 220, and a plurality of impact sensors 230. The reservoir 200, the pump 210, the plurality of spray nozzles 220, and the plurality of impact sensors 230 may be coupled to a truck 900. Responsive to an impact, the invention 100 may spray a fire suppression agent 270 carried within the reservoir 200 onto an impacting vehicle 920 to prevent ignition of a fire 930 or to extinguish the fire 930 such that the fire 930 is prevented from reaching a flammable cargo. As non-limiting examples, the truck 900 may comprise a tanker and the flammable cargo may be a fuel or a chemical.

It shall be noted that the truck 900 may be used with a tractor-trailer, but may also be a tank truck or a fuel truck. This patent application is not to be limited to either embodiment of the invention 100.

The reservoir 200 may be a container for storing the fire suppression agent 270. The fire suppression agent 270 may flow, either directly or indirectly, from the reservoir 200 to the pump 210. In some embodiments, the fire suppression agent 270 may flow from the reservoir 200 to the pump 210 due to gravity. In some embodiments, the fire suppression agent 270 may flow from the reservoir 200 to the pump 210 due to suction created by the pump 210. In some embodiments, the reservoir 200 may be vented to aid in the flow of the fire suppression agent 270. In some embodiments, the reservoir 200 may be coupled to the top of the tanker.

The pump 210 may move the fire suppression agent 270 from the reservoir 200 to the plurality of spray nozzles 220. The pump 210 may be electromechanical and may comprise an internal motor that may be energized by the application of an electrical potential to the pump 210. The source of the electrical potential may be the electrical system of the truck 900. As non-limiting examples, the pump 210 may move the fire suppression agent 270 by applying rotary motion, reciprocating motion, linear motion, or a combination thereof to one or more gears, screws, pistons, shuttle blocks, vanes, diaphragms, plungers, chains, ropes, impellers, or combinations thereof. In some embodiments, the pump 210 may be coupled to the reservoir 200.

The plurality of spray nozzles 220 may be coupled to the exterior of the truck 900 such that the plurality of spray nozzles 220 may be directed at the impacting vehicle 920. As a non-limiting example, the plurality of spray nozzles 220 may be mounted on a rear 902 of the truck 900 in anticipation of rear-end collisions by inattentive drivers. The fire suppression agent 270 may be pumped from the pump 210 to the plurality of spray nozzles 220 through tubing 260. The plurality of spray nozzles 220 may discharge the fire suppression agent 270 onto the impacting vehicle 920. In some embodiments, the plurality of spray nozzles 220 may be positioned at multiple heights, positioned at multiple lateral offsets, oriented in multiple directions, or any combination thereof in order to maximize a coverage area of the fire suppression agent 270.

The plurality of impact sensors 230 may be operable to detect the impact and to alert the pump 210 to the impact. An individual impact sensor may produce an electrical signal responsive to the impact. The electrical signal may be conveyed to the pump 210. Responsive to receiving the electrical signal from any of the plurality of impact sensors 230, the pump 210 may be energized by the electrical potential and may pump the fire suppression agent 270 to the plurality of spray nozzles 220.

In some embodiments, the plurality of impact sensors 230 may detect the impact via shock and/or vibration conveyed to the plurality of impact sensors 230 indirectly, even if the individual impact sensors are not struck.

The fire suppression agent 270 may extinguish the fire 930 and/or may prevent ignition of the fire 930. As a non-limiting example, the fire suppression agent 270 may be water. The fire suppression agent 270 may comprise chemical additives that increase the effectiveness of the fire suppression agent 270. In some embodiments, the fire suppression agent 270 may be a foaming agent that may be dispersed from the plurality of spray nozzles 220 as a fire suppressing foam.

In use, the invention 100 may be installed on a truck 900 by mounting the reservoir 200, the pump 210, the plurality of spray nozzles 220, and the plurality of impact sensors 230 on the truck 900. In a preferred embodiment, the plurality of spray nozzles 220 may be mounted on the rear 902 of the truck 900 in anticipation of a rear-end collision by an inattentive driver. The reservoir 200 may be filled with a fire suppression agent 270. If a collision occurs, one or more of the plurality of impact sensors 230 may detect the impact, either directly or indirectly, and may activate the pump 210. The pump 210 may pump the fire suppression agent 270 from the reservoir 200 to the plurality of spray nozzles 220 where the fire suppression agent 270 may be dispersed onto the impacting vehicle 920. The fire suppression agent 270 may prevent or extinguish a fire 930.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used herein, the words “couple”, “couples”, “coupled” or “coupling”, may refer to connecting, either directly or indirectly, and does not necessarily imply a mechanical connection.

As used in this disclosure, the word “exterior” may be used as a relational term that implies that an object is not located or contained within the boundary of a structure or a space.

As used herein, a “fire suppression agent” may extinguish, control, or prevent a fire from spreading or occurring.

As used herein, “front” may indicate the side of an object that is closest to a forward direction of travel under normal use of the object or the side or part of an object that normally presents itself to view or that is normally used first. “Rear” or “back” may refer to the side that is opposite the front.

As used in this disclosure, the word “lateral” may refer to the sides of an object or movement towards a side. Lateral directions are generally perpendicular to longitudinal directions. “Laterally” may refer to movement in a lateral direction.

As used in this disclosure, a “pump” may be a mechanical or electromechanical device that uses suction or pressure to raise or move fluids, compress fluids, or force a fluid into an inflatable object. As non-limiting examples, fluids may include both liquids, such as water, and gases, such as air.

As used herein, “reservoir” may refer to a container or containment system that is configured to store a liquid, gas, or gel.

As used in this disclosure, a “sensor” may be a device that quantitatively measures a physical stimulus.

With respect to the above description, it is to be realized that the optimum dimensional relationship for the various components of the invention described above and in FIGS. 1 through 4, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A fire suppression system for vehicles comprising:
a reservoir, a pump, a plurality of spray nozzles, and a plurality of impact sensors;
wherein the reservoir, the pump, the plurality of spray nozzles, and the plurality of impact sensors are coupled to a truck or a tanker;
wherein responsive to an impact, the fire suppression system for vehicles sprays a fire suppression agent carried within the reservoir onto an impacting vehicle to prevent ignition of a fire or to extinguish the fire such that the fire is prevented from reaching a flammable cargo.

2. The fire suppression system for vehicles according to claim 1
wherein the reservoir is a container for storing the fire suppression agent;
wherein the fire suppression agent flows from the reservoir to the pump.

3. The fire suppression system for vehicles according to claim 2
wherein the fire suppression agent flows from the reservoir to the pump due to gravity.

4. The fire suppression system for vehicles according to claim 2
wherein the fire suppression agent flows from the reservoir to the pump due to suction created by the pump.

5. The fire suppression system for vehicles according to claim 2
wherein the reservoir is vented to aid in the flow of the fire suppression agent.

6. The fire suppression system for vehicles according to claim 2
wherein the reservoir is coupled to the top of the truck or the tanker.

7. The fire suppression system for vehicles according to claim 2
wherein the pump moves the fire suppression agent from the reservoir to the plurality of spray nozzles.

8. The fire suppression system for vehicles according to claim 7
wherein the pump is electromechanical and comprises an internal motor that is energized by the application of an electrical potential to the pump.

9. The fire suppression system for vehicles according to claim 8
wherein the pump moves the fire suppression agent by applying rotary motion, reciprocating motion, linear motion, or a combination thereof to one or more gears, screws, pistons, shuttle blocks, vanes, diaphragms, plungers, chains, ropes, impellers, or combinations thereof.

10. The fire suppression system for vehicles according to claim 7
wherein the pump is coupled to the reservoir.

11. The fire suppression system for vehicles according to claim 7
wherein the plurality of spray nozzles are coupled to the exterior of the truck such that the plurality of spray nozzles are directed at the impacting vehicle.

12. The fire suppression system for vehicles according to claim 11
wherein the plurality of spray nozzles are mounted on a rear of the truck or the tanker.

13. The fire suppression system for vehicles according to claim 12
wherein the fire suppression agent is pumped from the pump to the plurality of spray nozzles through tubing;
wherein the plurality of spray nozzles discharge the fire suppression agent onto the impacting vehicle.

14. The fire suppression system for vehicles according to claim 13
wherein the plurality of spray nozzles are positioned at multiple heights, positioned at multiple lateral offsets, oriented in multiple directions, or any combination thereof in order to maximize a coverage area of the fire suppression agent.

15. The fire suppression system for vehicles according to claim 13
wherein the plurality of impact sensors are operable to detect the impact and to alert the pump to the impact;
wherein an individual impact sensor produces an electrical signal responsive to the impact;
wherein the electrical signal is conveyed to the pump;
wherein responsive to receiving the electrical signal from any of the plurality of impact sensors, the pump is energized by the electrical potential and pumps the fire suppression agent to the plurality of spray nozzles.

16. The fire suppression system for vehicles according to claim 15
wherein the plurality of impact sensors detect the impact via shock and/or vibration conveyed to the plurality of impact sensors indirectly.

17. The fire suppression system for vehicles according to claim 15
wherein the fire suppression agent extinguishes the fire and/or prevents ignition of the fire.

18. The fire suppression system for vehicles according to claim 17
wherein the fire suppression agent is water.

19. The fire suppression system for vehicles according to claim 17
wherein the fire suppression agent comprises chemical additives that increase the effectiveness of the fire suppression agent.

20. The fire suppression system for vehicles according to claim 17
wherein the fire suppression agent is a foaming agent that is dispersed from the plurality of spray nozzles as a fire suppressing foam.
